(19) United States
(12) Patent Application Publication
(10) Pub. No.: US 2012/0073570 A1
(43) Pub. Date: Mar. 29, 2012

(54) Collapsible Wind Proof Fuel Cell Frame with Portable Cooking Fuel Cell

(76) Inventors: Lloyd LeRoy Wall, Hildale, UT (US); Michael Pacharis, Temecula, CA (US); Jarrod Kuhn, Beaumont, CA (US)

(21) Appl. No.: 12/891,600

(22) Filed: Sep. 27, 2010

(51) Int. Cl. A47J 37/07

(52) U.S. Cl. 126/9 R

(57) ABSTRACT

A collapsible stove is disclosed wherein the stove may comprise first, second, third and fourth body portions that can be pivoted and collapsed such that the collapsed stove can be conveniently packed. Additionally, a fuel cell capable of achieving cooking temperatures may have a through hole formed within the fuel of the fuel cell. The through hole provides additional burning surface area and also additional air to the fuel being burned such that the maximum achievable temperature is at cooking temperatures.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The present invention relates to a cooking and/or warming stove and a fuel cell for cooking and/or warming.

Chafing fuels produce a flame to keep food warm during food service (e.g., buffet line). However, these chafing fuels are not used for cooking. Other cooking stoves exist for the purposes of cooking food. By way of example and not limitation, a propane base cooking stove may be used to cook food. However, the propane stove is typically large and inconvenient to carry. As such, these cooking stoves are typically not carried during backpacking trips, etc. Participants of a back country trip may utilize animals (e.g., mules, lamas, etc.) to assist them in bringing in cooking equipment. Unfortunately, this requires additional planning and expense.

Accordingly, there is a need in the art for an improved cooking stove.

### BRIEF SUMMARY

The present invention addresses the needs discussed above, discussed below and those that are known in the art.

A collapsible stove is provided. In particular, the collapsible stove may have first, second, third and fourth side portions which may be pivotally hinged to each other so as to allow the collapsible stove to be traversed between an erect position and a flat collapsed position. In the flat collapsed position, the collapsible stove may be conveniently stored within a backpack of a backpacker, military personnel, etc.

A fuel cell capable of achieving cooking temperatures is also provided. In particular, the fuel cell may comprise a container with fuel therein. The fuel may have a through hole extending from a top surface of the fuel to a bottom surface thereof. The container may have an upper aperture and a lower aperture which are aligned to the through hole such that air may flow through the fuel cell during use. The through hole provides additional burning surface area and additional oxygen or air to further enhance burn. By this structure, a higher maximum temperature is achievable compared to prior art chafing fuels.

More particularly, a collapsible stove supportable on a support surface is disclosed. The stove may comprise a body, at least one fuel cell support tab, at least three legs and at least three supports. The body may have first, second, third and fourth portions. Each of the first, second, third and fourth portions may define opposed vertical edges and opposed upper and lower edges. The opposed vertical edges of the first portion may be pivotally hinged to one of the opposed edges to the fourth and second portions. The opposed vertical edges of the third portion may be pivotally hinged to the other one of the opposed edges of the fourth and second portions. The first, second, third and fourth portions may be traversable between collapsed position for storing and transporting the stove and erected position for supporting a cooking pot.

The at least one fuel cell support tab may be connected adjacent to at least one of the lower edges of the first, second, third and fourth portions. The at least three legs may extend below the lower edges of the first, second, third and fourth portions for supporting the first, second, third and fourth portions above the support surface and allowing air to flow beneath the body during use. The at least three supports may support a cooking pot. The at least three supports may extend above the upper edges of the first, second, third and fourth portions to allow air to flow above the body during use.

There are at least three legs that may extend wider than the first, second, third and fourth portions to provide a stable support. Also, there may be at least three legs that may be rotateable toward inner sides of the first, second, third and fourth body portions. A respective pair of each of the legs and supports may be fabricated from a unitary wire member extending through two opposed vertical edges of the first, second, third and fourth portions. The supports may be flared upwardly so that the cooking pot rests on distal end portions of the supports. The first, second, third and fourth portions may collectively have a circular configuration when the first, second, third and fourth portions are traversed to the erected position.

A portable cooking fuel is also disclosed. The fuel may comprise a container and a solid or pseudo solid combustible fuel. The container may define a top surface and an opposed bottom surface. The top surface may have a first opening. The bottom surface may have a second opening. The solid or pseudo solid combustible fuel may be disposed within the container. The solid or pseudo solid combustible fuel may have a through hole which is in fluid communication with the first and second openings of the container to allow air to flow through the through hole of the solid combustible fuel.

The through hole may have a cylindrical configuration. The through hole may alternatively have a frusto conical configuration, multi point configuration, square configuration, elliptical configuration, triangular configuration.

The container may have two or more second openings. The fuel may have a corresponding number of through holes which are each in fluid communication with one second opening. Each of the through holes may be in fluid communication with the first opening.

A portable cooking system is disclosed. The system may comprise a container and retainer wall. The container may hold fuel. Also, the container may define a height and have an open top and a lower aperture which defines an inner peripheral edge. The retainer wall may define a height and extend from the inner peripheral edge of the lower aperture into the container. The height of the retainer wall may be less than a height of the container height.

The retainer wall may have a lower opening and an upper opening which is smaller than the lower opening for forming a venture to assist in increasing air speed through the lower aperture of the container. Also, the portable cooking system may further comprise a solid or pseudo solid fuel insertable into the container. The fuel may have a through hole defining an inner diameter which may be greater than an outer diameter of the retainer wall.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of a collapsible portable stove comprising a frame and fuel cell;

FIG. 2 is a perspective view of the fuel cell;

FIG. 3 is a front view of the frame in an erected position;

FIG. 4 is a top view of the frame in a collapsed position;

FIG. 5 is a perspective view of the frame and two fuel cells;

FIG. 6 is a cross sectional side view of the fuel cell shown in FIG. 2;

FIG. 6A illustrates an alternate embodiment of the fuel cell shown in FIG. 6;

FIG. 6B illustrates a further alternate embodiment of the fuel cell shown in FIG. 6;

FIG. 6C illustrates a further alternate embodiment of the fuel cell shown in FIG. 6;

FIG. 7 is a cross sectional top view of the fuel cell shown in FIG. 2;

FIG. 7A illustrates an alternate embodiment of the fuel cell shown in FIG. 7;

FIG. 7B illustrates a further alternate embodiment of the fuel cell shown in FIG. 7;

FIG. 7C illustrates a further alternate embodiment of the fuel cell shown in FIG. 7;

FIG. 8 is a cross sectional side view illustrating an alternate embodiment of the fuel cell;

FIG. 9 is a perspective view of a fuel insertable into a reusable container having a venturi; and

FIG. 10 is a cross sectional view of the fuel and container shown in FIG. 9.

### DETAILED DESCRIPTION

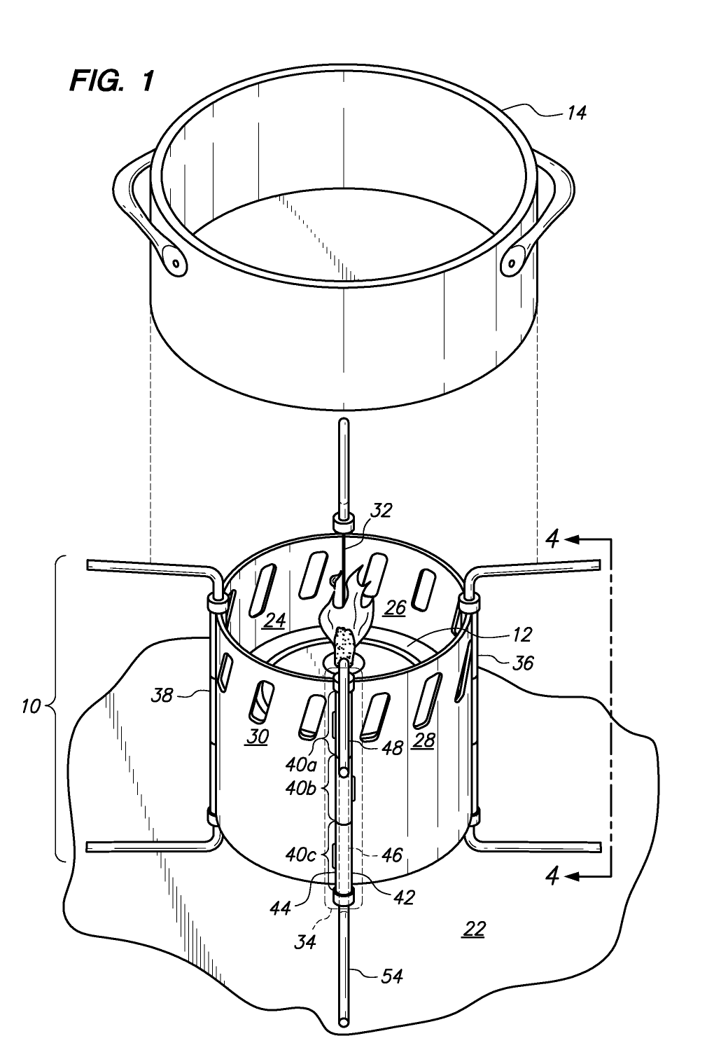

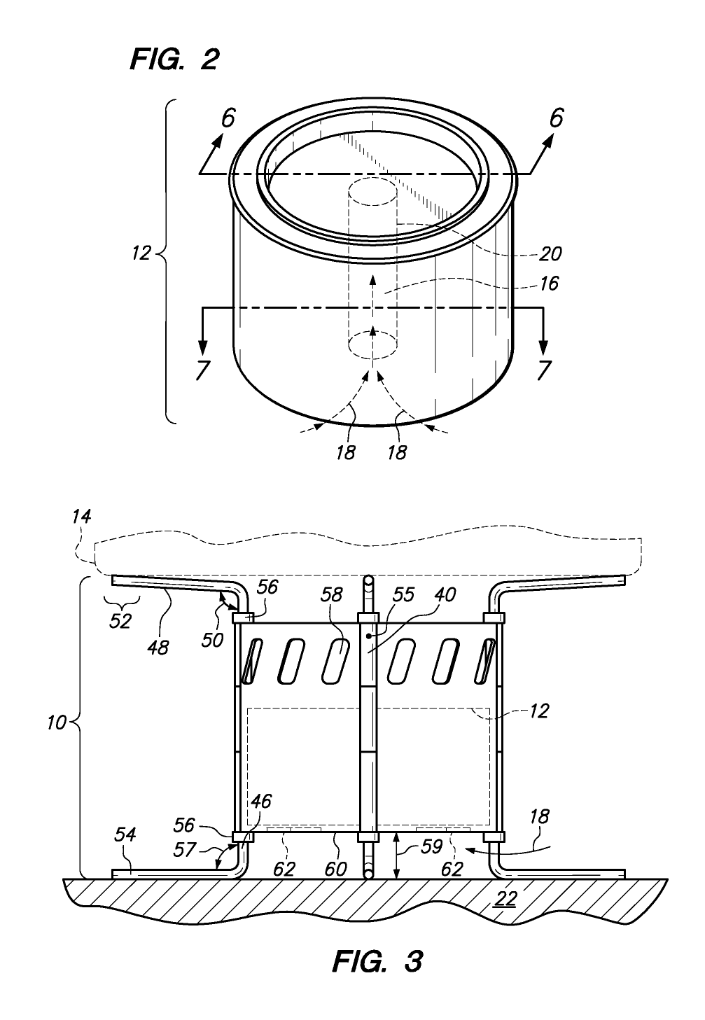

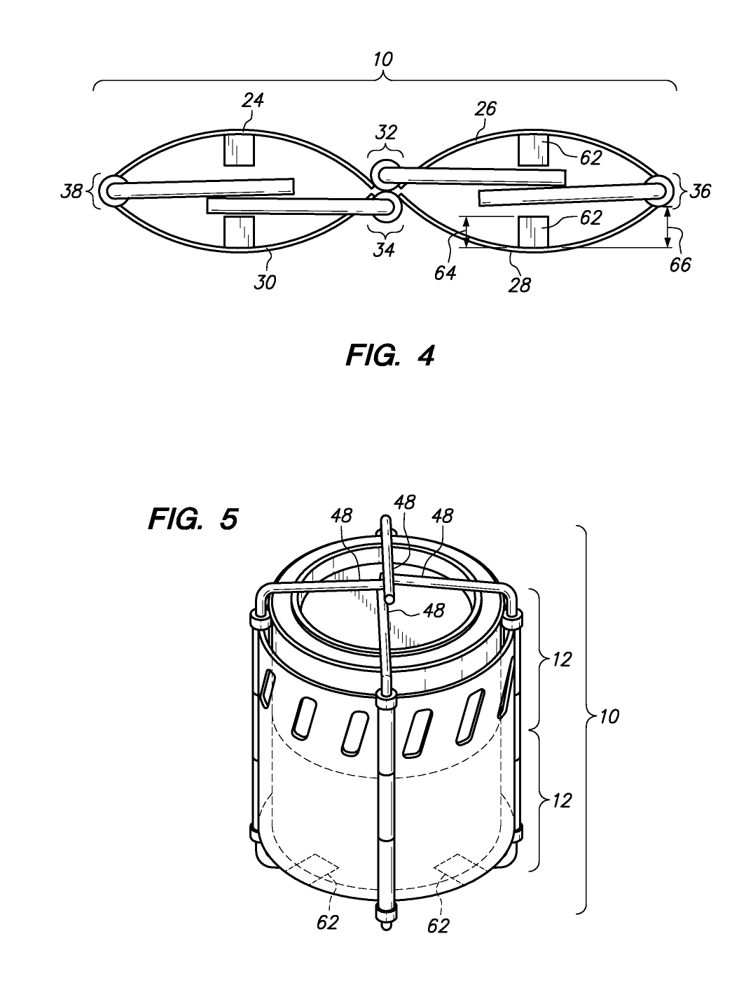

Referring now to FIG. 1, a stove comprising a collapsible wind proof fuel cell frame 10 with a portable cooking fuel cell 12 disposed within the frame 10 is shown. A pot 14 can rest on top of the frame 10 such that heat from the cooking fuel cell 12 may cook the contents within the pot 14. As shown in FIG. 2, the fuel cell 12 may have a through hole 16 from the bottom to the top to allow air 18 to flow through the fuel cell 12. The additional air 18 flowing through the fuel cell 12 and additional surface burning area 20 of the fuel cell 12 allows the fuel cell 12 to produce a maximum temperature sufficient to cook food and not just warm food. When the fuel cell 12 is disposed within the frame 10, the frame 10 lifts the fuel cell 12 above a support surface 22 upon which the frame 10 rests, as shown in FIG. 3. This allows air to flow underneath the fuel cell 12 and flow through the through hole 16 of the fuel cell 12. Alternatively, the through hole 16 may be blocked from the bottom such that the air does not flow through the through hole 16 of the fuel cell 12. In this scenario, the maximum temperature of the fuel cell 12 may not reach a cooking temperature, but a warming temperature. Moreover, the frame 10 is collapsible to a compact generally flat configuration, as shown in FIG. 4 such that the frame 10 may be conveniently stored during transport in a backpack during back country trips, military personnel's gear, emergency situations, etc.

Still referring to FIG. 4, the frame 10 may comprise first, second, third and fourth side portions 24, 26, 28 and 30. The first side portion 24 is pivotally hinged to the second and fourth side portions 26, 30. The second side portion 26 is pivotally hinged to the first and third side portions 24, 28. The third side portion 28 is pivotally hinged to the second and fourth side portions 26, 30. The fourth side portion 30 is pivotally hinged to the first and third side portions 24, 28. In FIG. 4, the frame 10 is shown in the collapsed position. In contrast, the frame 10 may be traversed to the erected position, as shown in FIG. 1. To this end, the first, second, third and fourth side portions 24, 26, 28 and 30 are pivoted as needed. The hinges 32, 34 of the first and second side portions 24, 26 and the third and fourth side portions 28, 30 are drawn closer to each other or further apart when the frame 10 is traversed from the erected position (see FIG. 1) to the collapsed position (see FIG. 3) or vice versa.

The hinge 34 may be formed in the following manner. As shown in FIG. 1, the third side portion 28 may have one or more tubular members 40b attached (e.g., welded or formed in place) thereto. The tubular member 40b may be formed at a vertical side edge 42 of the third side portion 28. The fourth side portion 30 may also have one or more tubular members 40a, c attached (e.g., welded or formed in place) at its vertical side edge 44. The tubular members 40a, b, c of the third and fourth side portions 28, 30 are aligned and interlocked by inserting a rod 46 through the tubular members 40a, b, c. The third and fourth side portions 28, 30 are allowed to pivot about the rod 46 forming the hinge 34. The other hinges 32, 36, 38 may also be formed in the same manner.

Referring now to FIG. 3, the frame 10 is supportable on a support surface 22 and can also support a pot 14. The rod 46 may be bent at its upper end portion to form the pot support leg 48. The pot support leg 48 may be bent at an obtuse angle 50 such that distal end portions 52 of the pot support leg 48 contacts the underside of the pot 14 thereby providing the widest stable base for the pot 14. Additionally, the lower end portion of the rod 46 may be bent so as to form the stove support leg 54. The support leg 54 may also be formed at an obtuse angle 50 but is shown as being formed perpendicular 57 to the rod 46.

The pot support leg 48, rod 46 and the stove support leg 54 may all be fabricated from a unitary material such as stainless steel round rod or wire. The pot support leg 48 and the stove support leg 54 may be rotated such that they form the widest possible support. To this end, preferably, the pot support leg 48 and the stove support leg 54 all extend outwardly when the frame 10 is in the erected position, as shown in FIG. 1. To maintain the position of the pot support legs 48 and stove support legs 54, the tubular member 40 may have a dipple 55 (see FIG. 3). The dipples 55 provide frictional interference between the tubular member 40a and the rod 46.

The first, second, third and fourth side portions 24, 26, 28 and 30 may all be raised above the support surface 22 to allow air flow 18 underneath the first, second, third and fourth side portions 24, 26, 28 and 30, as shown in FIG. 3. To this end, a collar 56 may be attached on each of the rods 46 on opposed sides of the side portions 24, 26, 28 and 30. The collars 56 are fixedly attached to the rods 46 such that the side portions 24, 26, 28 and 30 cannot slide up and down the rod 46. Alternatively, the collars 56 may be replaced with a solder material or weld material such that the first, second, third and fourth side portions 24, 26, 28 and 30 cannot slide along the rod 46 yet the first, second, third and fourth side portions 24, 26, 28 and 30 are allowed to pivot about the respective rods 46.

To further aid in providing oxygen to the fuel cell 12 disposed within the frame 10, one or more of the first, second, third and fourth side portions 24, 26, 28 and 30 may be formed with air vents 58. The distance 59 between the lower edge 60 of the side portions 24, 26, 28 and 30 to the support surface 22 and the size and number of air vents 58 may be sized and configured to provide an optimal amount of air to the fuel cell 12 disposed within the frame 10.

To hold the fuel cell 12 above the support surface 22, the frame 10 may have one or more tabs 62 (see FIGS. 3 and 4). The fuel cell 12 rests upon the tabs 62 when the fuel cell 12 is disposed within the frame 10. The tabs 62 may be attached to one or more of the first, second, third and fourth side portions 24, 26, 28 and 30. The air vents 58 are preferably disposed above the fuel cell 12 as shown in FIG. 3. The side portions 24, 26, 28 and 30 form a wind barrier such that during outside use of the stove, the wind (e.g., high or low winds) does not blow out the flame of the fuel cell 12. Yet, the air vent 58 allows air flow to reach the fuel cell 12.

To collapse the frame 10, the fuel cell 12 must be removed from the frame 10. The hinges 32, 34 may then traversed closer to each other. This action also traverses the hinges 36, 38 further apart from each other. Since the side portions 24, 26, 28 and 30 have a curved configuration, the tabs 62 which are formed on the first, second, third and fourth side portions 24, 26, 28 and 30 do not interfere with each other (see FIG. 4). Rather, a length 64 of the tabs 62 is equal to or less than a depth 66 of the curvature of each of the side portions 24, 26, 28 and 30. After the side portions 24, 26, 28 and 30 are collapsed to the flat configuration shown in FIG. 4, the pot support legs 48 and the stove support legs 54 are rotated inwardly such that they do not stick out. This provides a compact configuration to allow the frame 10 to be conveniently stored within a back country backpacker's backpack or a military gear pack.

Beneficially, the first, second, third and fourth side portions 24, 26, 28 and 30 may be fabricated from a metallic material (i.e., stainless steel, aluminum, etc.) that is sufficient to withstand the cooking temperature produced by the fuel cell 12. Alternatively, the side portions 24, 26, 28 and 30 may be fabricated from other types of material such as high temperature plastics, high temperature carbon fiber material to further reduce the weight of the frame 10. The rod 46, pot support leg 48 and stove support leg 54 may be fabricated from a unitary material such as stainless steel, or other generally rigid and high temperature material. The frame 10 may be fabricated from material capable of withstanding the maximum temperature of the fuel cell 12. As such, repeated usage of the frame 10 does not significantly deteriorate the structure of the frame 10. Additionally, the frame 10 is sufficiently small such that manufacture of the frame 10 with metallic material does not add considerable weight. Fabricating the frame 10 from lighter materials but high temperature resistant such as plastics and carbon fiber will further reduce the weight of the frame 10. The rod 46 may have a circular cross sectional configuration to facilitate pivoting of the side portions 24, 26, 28 and 30 about the respective hinges 32, 34, 36 and 38.

To traverse the frame 10 from the collapsed position (see FIG. 3) to the erected position (see FIG. 1), the hinges 32, 34, may be traversed away from each other. This brings the hinges 36, 38 closer to each other. The side portions 24, 26, 28 and 30 all have curved configurations such that collectively they form a circle (see FIG. 1). The side portions 24, 26, 28 and 30 are sized and configured such that the fuel cell 12 which also may have a circular configuration may be dropped into the frame 10. The tabs 62 hold the fuel cell 12 above the support surface 22 such that air is provided below the fuel cell 12 during use. The stove support legs 54 are adjusted outwardly so as to provide a wide stable base. Since the stove support leg 54 is fabricated from a unitary material with the pot support leg 48, the pot support leg 48 is adjusted simultaneously with the stove support legs 54.

For packing and/or sales purposes, the frame 10 and two fuel cells 12 may be provided, as shown in FIG. 5. Tabs 62 prevent the fuel cells 12 from falling out of the bottom of the frame 10. Additionally, the pot support legs 48 are rotated inwardly to prevent the fuel cells 12 from slipping out of the top of the frame 10. This provides a complete frame 10 and fuel cell 12 package that may be provided to customers initially.

Referring now to the fuel cell 12 shown in FIGS. 2 and 6-7C, the fuel cell 12 may comprise a container 68 which holds solid fuel 70. The fuel 70 may be a solid or pseudo solid combustible material and formed with the through hole 16. The container 68 may have an upper lid 72 and a lower lid 74. The upper and lower lids 72, 74 may be frictionally fitted to upper and lower aperture edges 76, 78 of the container 68. The lids 72, 74 are removably attachable from the container 68 such that the lids 72, 74 may be removed during use and reattached to the container 68 if some fuel 70 is still left over after use. The through hole 16, upper aperture 80 and lower aperture 82 may be aligned to each other such that air 18 may flow through the through hole 16 during use. Preferably, the upper aperture 80 is substantially larger than the lower aperture 82. The size of the upper aperture and lower aperture 80, 82 may be adjusted to regulate the maximum temperature achievable by the fuel cell 12 and also to regulate the fuel burn rate. Generally, the larger the openings 80, 82, the greater the maximum temperature and higher the fuel burn rate, and vice versa. Also, the upper plate 84 of the container is gapped away 86 from an upper surface 88 of the fuel 70.

During use, the operator removes the upper and lower lids 72, 74. The fuel cell 12 is disposed within the frame 10. With the fuel cell 12 disposed within the frame 10, the tabs 62 supports the fuel cell 12 above the support surface 22. Air 18 is allowed to flow underneath the first, second, third and fourth side portions 24, 26, 28 and 30 of the frame 10 and through the through hole 16 of the fuel cell 12. The operator ignites the fuel 70 to thereby burn the upper surface 88 as well as the additional burning surface area 20 which is the surface area defining the through hole 16 of the fuel cell 12. The additional burning surface area 20 and the additional air 18 delivered to the fuel 70 provides an increased temperature such that the fuel cell 12 may reach a cooking temperature and not merely a warming temperature as is the case for chafing fuels. With the higher temperatures, a higher fuel burn rate is also obtained.

Preferably, the lower aperture edge 78 of the container 68 is the same size as the lower opening of the through hole 16. As such, the fuel 70 burns radially outward from the additional burning surface 20 and also downwardly from the upper surface 88.

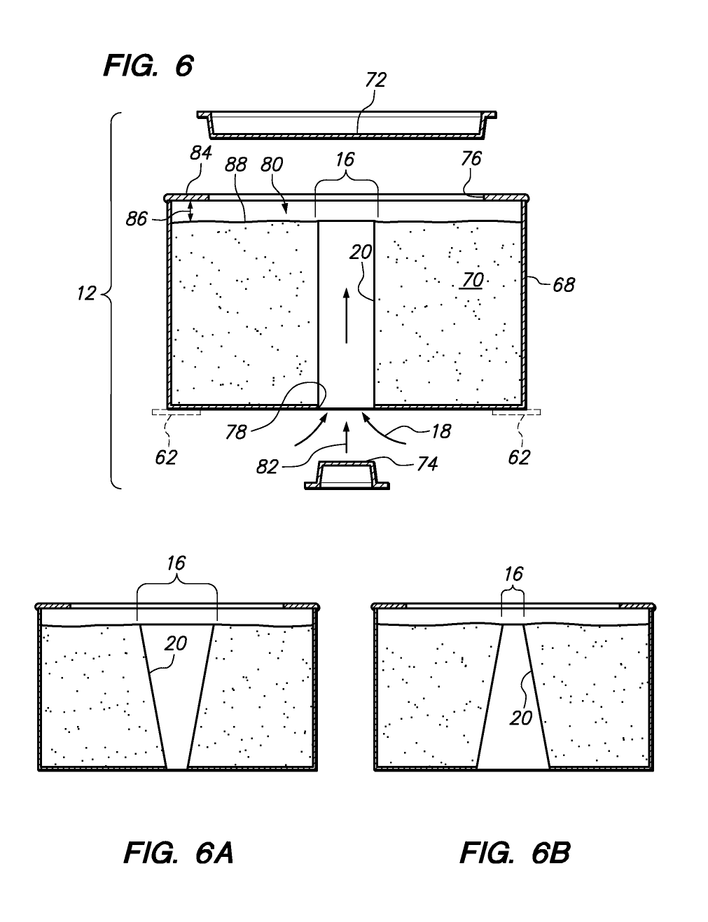

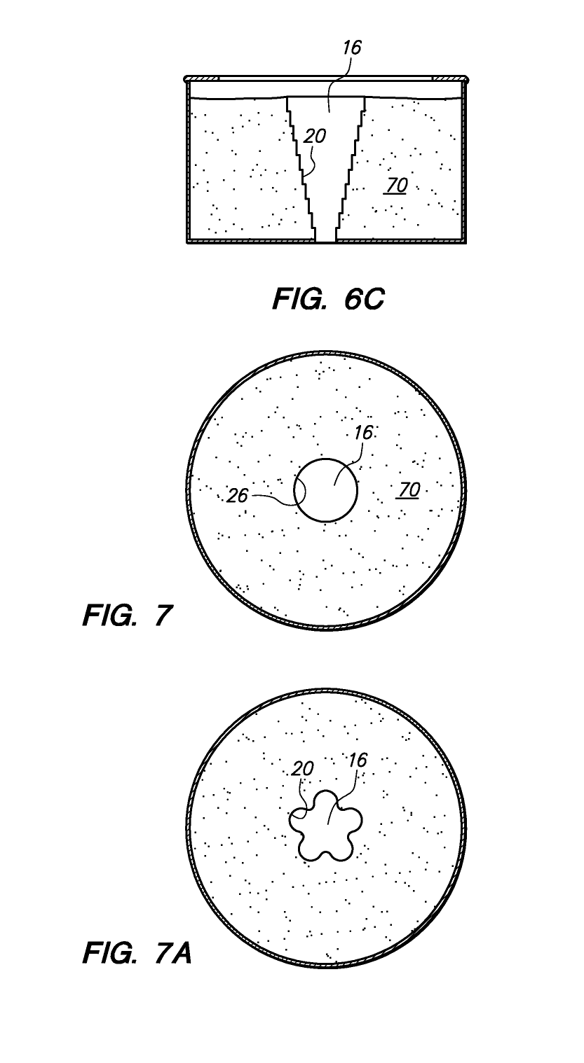

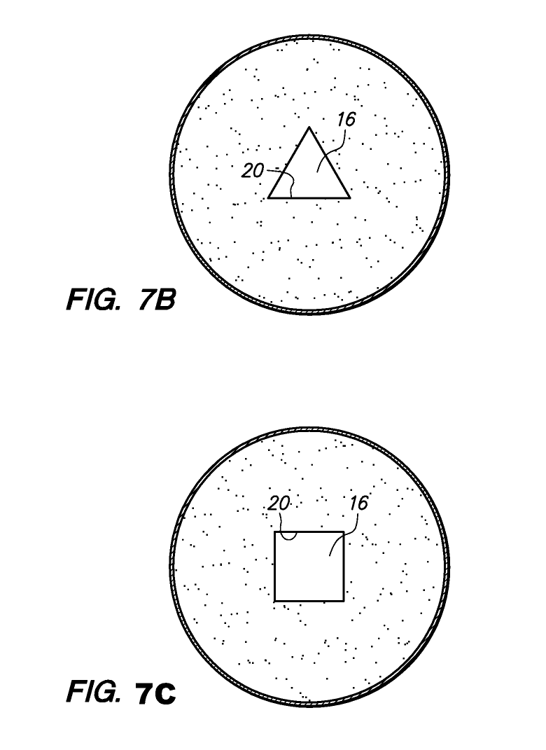

In order to adjust the maximum temperature of the fuel cell 12, the total surface burning area of the fuel cell 12 may be adjusted. In FIG. 6, the total burning surface area is equal to the area of the upper surface 88 as well as the inner surface 20 of the through hole 16. Other configurations of the through hole 16 are also contemplated as shown in FIGS. 6A, 6B, 6C as well as FIGS. 7-7C to increase or decrease the total burning surface area (upper surface 88 plus additional burning surface area 20) thereby increasing or decreasing the maximum temperature producible by the fuel cell 12 such that the fuel cell 12 can be used to warm or cook foods. In particular, FIG. 6A illustrates a frusto conical through hole 16. FIG. 6B illustrates an inverted frusto conical aperture. FIG. 6C illustrates a stair stacked conical aperture. In FIGS. 6A-6C, the vertical cross sectional configuration of the through hole 16 is adjusted to increase or decrease the amount of additional burning surface area 20.

With respect to FIGS. 7-7C, the horizontal cross sectional configuration is altered to adjust the amount of additional burning surface area 20. In particular, in FIG. 7, a circular through hole 16 is shown. FIG. 7A illustrates a multi point cross sectional configuration of the through hole 16 to increase the additional burning surface area 20 compared to that shown in FIG. 7. FIG. 7B illustrates a triangular and FIG. 7C illustrates a square cross sectional configuration of the through hole 16. Other configurations are also contemplated such as star configurations and cross configurations.

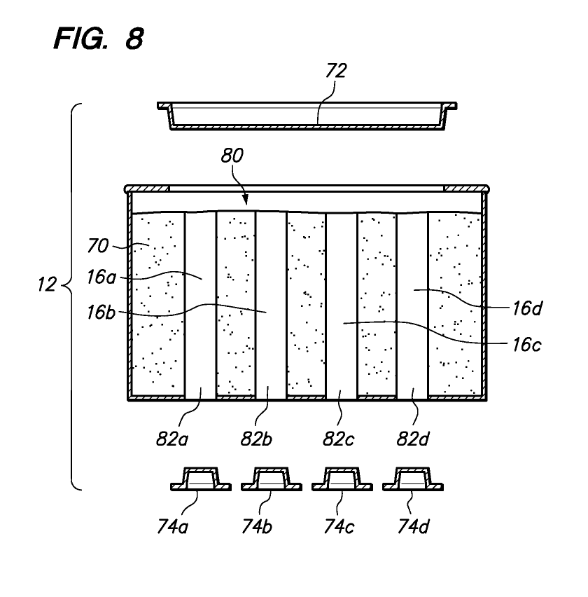

The fuel cell 12 shown in FIGS. 6-7C all illustrate a single through hole 16. However, it is also contemplated that multiple through holes 16a-n may be formed in the fuel 70 as shown in FIG. 8. For example, in FIG. 8, there are four through holes 16a-d. For each through hole 16a-d, a lower aperture 82a-d may be aligned to such through hole 16a-d and plugged with a lid 74. In all embodiments, a single upper aperture 80 is in fluid communication with the one or more through holes 16a-n. The additional through holes 16a-n provide additional burning surface area to increase the maximum temperature achievable by the fuel cell 12. Each of the lower apertures 82a-d may be selectively plugged with a lower lid 74a-d to regulate the amount of air or oxygen flowing through the fuel cell 12 and through hole 16a-d. By way of example and not limitation, if four through holes 16a-d are formed through the fuel 70, all lower apertures 82a-d may be left open during use. This will produce the maximum temperature achievable by the fuel cell 12. To reduce the maximum temperature, one of the through holes 16a may be plugged with a lid 74a. To further reduce the maximum temperature of the fuel cell 12, another through hole 16b may be plugged with a second lower lid 74b, and so on. When all of the lower apertures 82 are plugged with lids 74a-d, then the fuel cell 12 has reached its lowest maximum temperature achievable. As such, the number of through holes 16a-n, and shapes or configurations of the through holes 16a-n, may be configured to regulate the temperature output of the fuel cell 12.

As the maximum temperature of the fuel cell 12 increases, the burn rate of the fuel 70 also increases.

The fuel cell 12 described herein used in conjunction with the frame 10 has a through hole 16. However, it is also contemplated that the frame 10 may be employed with a regular chafing fuel including but not limited to liquid, gel and solid fuel cells. These cells do not have a through hole.

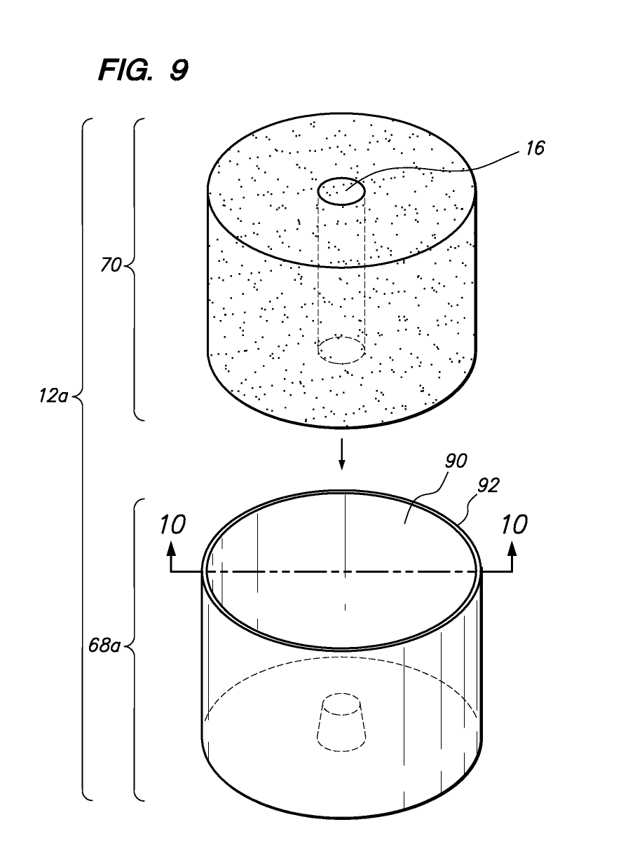

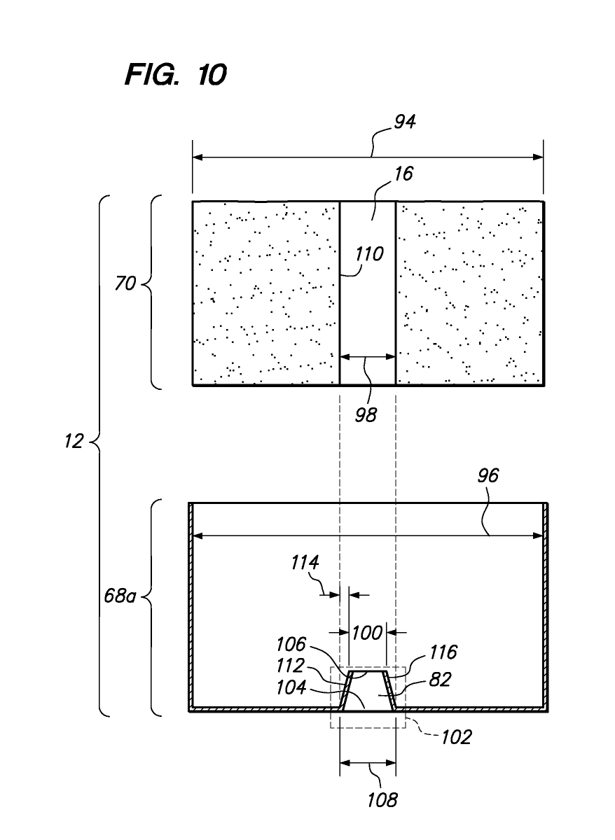

Referring now to FIGS. 9 and 10, a reusable container 68a is shown. The fuel 70 may be in solid or pseudo solid form and insertable into the reusable container 68a. When the fuel 70 has been fully combusted, another replacement fuel 70 may be inserted into the reusable container 68a. In this manner, the container 68a is not thrown away but recycled in order to lower the operational cost of the fuel cell 12a. To this end, the reusable container 68a may have an open top 90 with a straight edge 92. The reusable container 68a preferably does not have an upper surface 84 as in the container 68 (see FIG. 6). Referring now to FIG. 10, an outer diameter 94 of the fuel cell 70 may be substantially equal to an inner diameter 96 of the container 68a. Preferably, the fuel 70 has a tight snug fit within the container 68a. The solid or pseudo solid fuel 70 shown in FIG. 10 may have a hollow core defined by through hole 16. The through hole 16 shown in FIGS. 9 and 10 is shown as being circular but may have any configuration (e.g., frusto conical configuration, multi point configuration, square configuration, elliptical configuration, triangular configuration, etc.) as discussed herein and shown in the drawings. Additionally, one or more through holes 16a-n may be formed in the fuel 70 with a corresponding number of lower apertures 82a-n formed in the reusable container 68a. An inner diameter 98 of the through hole 16 may be greater than an outer diameter 100 of a venturi 102 or an upper opening 106 of the venturi 102 formed in the reusable container 68a. The venturi 102 may have a larger lower opening 104 in fluid communication with a smaller upper opening 106. Preferably, the inner diameter 98 of the through hole 16 formed in the fuel 70 is equal to a diameter 108 of the larger lower opening 104. The venturi 102 may assist in achieving a higher rate of air speed through the through hole 16 to increase the maximum temperature achievable by the fuel cell 12. Additionally, by fabricating the inner diameter 98 of the through hole 16 of the fuel 70 to be greater than the outer diameter 100 of the venturi 102 or the smaller upper opening 106, there is a gap 114 between an interior surface 110 of the through hole 16 and an interior surface 112 of the venturi 102. As the fuel 70 burns, unburnt fuel 70 may drop downward and be caught within the retaining wall 116 of the container 68a such that unburnt fuel 70 does not fall through the lower aperture 82 thereby providing a clean use fuel cell 12a. It is contemplated that the venturi 102 may also be incorporated into the fuel cell 12 shown in FIGS. 2 and 6-7C.

The frame 10 and fuel cell 12 discussed herein provide for a versatile and convenient to carry and transport equipment which may be used for military, recreational and emergency use. The fuel cell 12, 12a may be configured to provide a maximum temperature for warming food or a maximum temperature for cooking food. The fuel cell 12, 12a may be configured to provide a range of different maximum temperature output. The frame 10 is lightweight and does not deteriorate upon use. As such, the frame 10 may be repeatedly used for a significantly long period of time. The frame 10 is collapsible such that the frame 10 and fuel cell 12 may be conveniently packed and transported in the field and in backpacking trips, etc.

The above description is given by way of example, and not limitation. Given the above disclosure, one skilled in the art could devise variations that are within the scope and spirit of the invention disclosed herein, including various ways of forming hinges 32, 34, 36 and 38. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A collapsible stove supported on a support surface, the stove comprising:
a body having first, second, third and fourth portions, each of the first, second, third and fourth portions defining opposed vertical edges and opposed upper and lower edges, the opposed vertical edges of the first portion being pivotally hinged to one of the opposed edges to the fourth and second portions, the opposed vertical edges of the third portion being pivotally hinged to the other one of the opposed edges of the fourth and second portions, the first, second, third and fourth portions being traversable between collapsed position for storing and transporting the stove and erected position for supporting a cooking pot;
at least one fuel cell support tabs connected adjacent to at least one of the lower edges of the first, second, third and fourth portions;
at least three legs extending below the lower edges of the first, second, third and fourth portions for supporting the first, second, third and fourth portions above the support surface and allowing air to flow beneath the body during use;
at least three supports for supporting a cooking pot, the at least three supports extending above the upper edges of the first, second, third and fourth portions to allow air to flow above the body during use.

2. The stove of claim 1 wherein the at least three legs extend wider than the first, second, third and fourth portions to provide a stable support.

3. The stove of claim 2 wherein the at least three legs are rotateable toward inner sides of the first, second, third and fourth body portions.

4. The stove of claim 1 wherein a respective pair of each of the legs and supports are fabricated from a unitary wire member extending through two opposed vertical edges of the first, second, third and fourth portions.

5. The stove of claim 1 wherein the supports are flared upwardly so that the cooking pot rests on distal end portions of the supports.

6. The stove of claim 1 wherein the first, second, third and fourth portions collectively have a circular configuration when the first, second, third and fourth portions are traversed to the erected position.

7. A portable cooking fuel comprising:
a container defining a top surface and an opposed bottom surface, the top surface has a first opening, the bottom surface has a second opening;
a solid or pseudo solid combustible fuel disposed within the container, the solid a pseudo solid combustible fuel having a through hole which is in fluid communication with the first and second openings of the container to allow air to flow through the through hole of the solid combustible fuel.

8. The fuel of claim 7 wherein the through hole has a cylindrical configuration.

9. The fuel of claim 7 wherein the through hole has a frusto conical configuration, multi point configuration, square configuration, elliptical configuration, or triangular configuration.

10. The fuel of claim 7 wherein the container has two or more second openings, and the fuel has a corresponding number of through holes which are each in fluid communication with one second opening, each of the through holes being in fluid communication with the first opening.

11. A portable cooking system comprising:
a container for holding fuel, the container defining a height and having an open top and a lower aperture which defines an inner peripheral edge;
a retainer wall defining a height and extending from the inner peripheral edge into the container, the height of the retainer wall being less than a height of the container height.

12. The portable cooking system of claim 11 wherein the retainer wall has a lower opening and an upper opening which is smaller than the lower opening for forming a venture to assist in increasing air speed through the lower aperture of the container.

13. The portable cooking system of claim 11 further comprising a solid or pseudo solid fuel insertable into the container, the fuel having a through hole defining an inner diameter, the inner diameter of the through hole being greater than an outer diameter of the retainer wall.
